(19) United States
(12) Patent Application Publication
(10) Pub. No.: US 2003/0217621 A1
(43) Pub. Date: Nov. 27, 2003

(54) Corkscrew

(76) Inventor: Chiou Jing Su, Taipei (TW)

Correspondence Address: SU Chiou Jing, PO Box 82-144, TAIPEI, TW

(21) Appl. No.: 10/153,697

(22) Filed: May 24, 2002

(51) Int. Cl. B67B 7/44

(52) U.S. Cl. 81/3.09

(57) ABSTRACT

A corkscrew comprised of an outer tube, an inner tube, and a slide needle holder that allows safe and fast removal of a cork in a bottle with a retractable needle by rotating the inner tube to drive the slide needle holder to either extend or retreat for use or for storage with reduced length of the corkscrew; and additionally adapted with a foil cutter to facilitate the subsequent cutting of the foil that covers the opening of the bottle.

### BACKGROUND OF THE INVENTION

(a) Field of the Invention

The present invention is related to an improved structure of a corkscrew, and more particularly to one that is adapted with a foil cutter to allow fast removal of a cork and easy retreat.

(b) Description of the Prior Art

In a social occasion, usually dinning and drinks are served. Liquors such as Port, Hock, Claret or firewater are usually served in bottles sealed with corks. A cork is used to prevent ingress of air into the bottle to ensure that the wine maintains its best quality because that the cork is able to return to its original shape whenever deformed by pressure.

There are many corkscrews generally available in the market. As illustrated in FIG. 1, a corkscrew of the prior art relates to one that allows safe and fast removal of the cork with least destruction. It is comprised of a tube (9) with a needle (91) to pierce through a cork (7) and a coolant canister (8) inserted in the tube (9). By gently pressing the coolant canister for a couple of seconds to inject pressurized coolant air into the bottle to increase positive pressure therein, thus to easily push out the cork.

However, the corkscrew of the prior art is found with the following defects:

1. The needle (91) is comparatively long and in smaller diameter, a cap (92) is provided to the needle (91) when the corkscrew is not used, making the corkscrew even longer to prevent easy storage.

2. Furthermore, a foil is usually provided to cover the opening of the bottle. A cutter must be separately prepared to cut the foil before removing the cork.

### SUMMARY OF THE INVENTION

The present invention is related to an improved structure of a corkscrew, and more particularly to one that is adapted with a foil cutter to allow fast removal of a cork and easy retreat.

The primary purpose of the present invention is to provide a corkscrew that allows fast removal of a cork. To achieve the purpose, a needle is provided in a slide holder to make it retractable in a tube thus to reduce the overall length of the corkscrew for easy portability.

The secondary purpose of the present invention is to provide a corkscrew that facilitates the withdrawal from the cork. To achieve the purpose, a foil cutter is adapted to the front of the corkscrew by cutting the foil.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a safety corkscrew of the prior art.

FIG. 2 is a blowup view of a preferred embodiment of the present invention.

FIG. 3 is schematic view showing how an assembly of the preferred embodiment of the present invention is related to its members.

FIG. 4 is a schematic view showing that the preferred embodiment of the present invention in use.

FIG. 5 is a schematic view showing an operation of a foil cutter of the preferred embodiment of the present invention.

FIG. 6 is a sectional view taken from A-A as illustrated in FIG. 5.

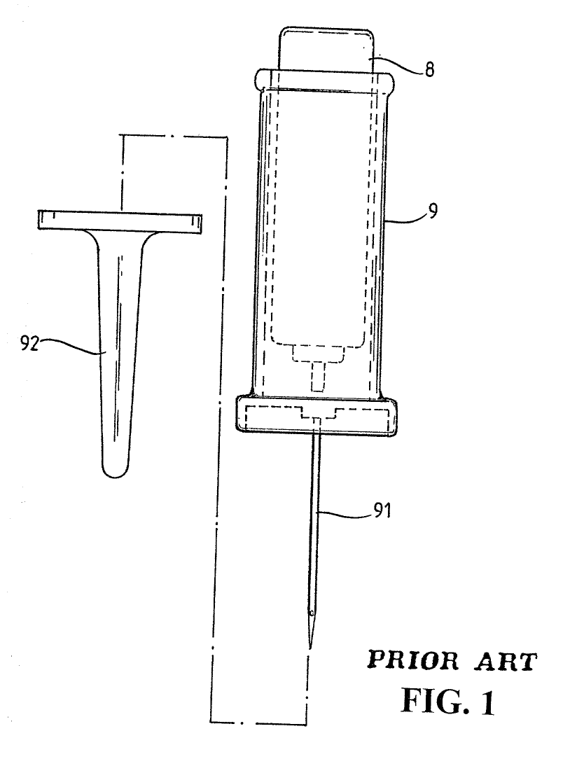

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

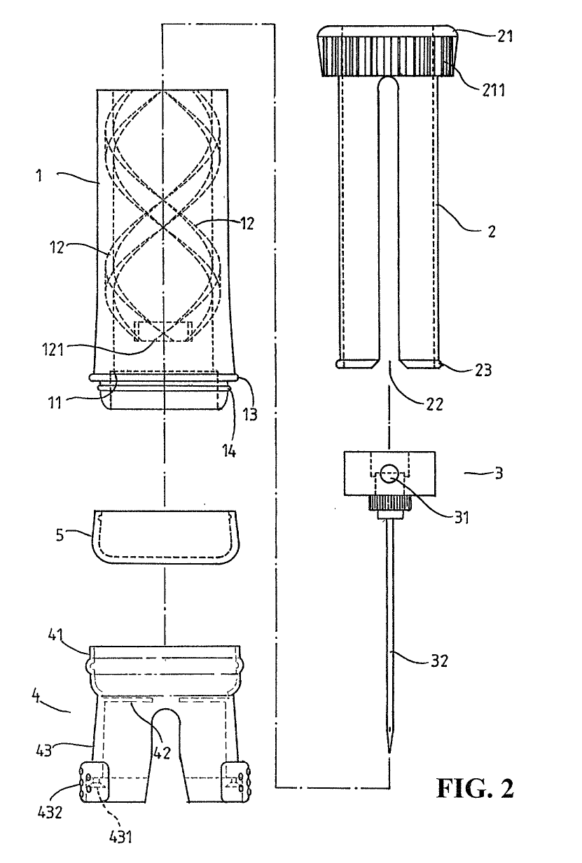

Referring to FIG. 2, a preferred embodiment of the present invention is essentially comprised of an outer tube (1), an inner tube (2), a slide needle holder (3) and a foil cutter (4). Wherein, the outer tube (1) has its lower diameter slightly larger than its upper diameter; a locking edge (11) defined by fall is formed on the lower circumference of the inner diameter; two recessed, boring lines (12) in spiral pattern at a proper angle are formed in the outer tube (1) then terminated to form a flush trough (121) at aright angle to an axis of the outer tube (1); and a first and a second flanges (13, 14) are formed at the front end of the outer diameter of the outer tube (1) with the first flange (13) in a diameter slightly larger than the outer diameter of the outer tube (1) while the second flange (13) is provided at where appropriately on a tapered bottom of the outer tube (1).

The inner tube (2) having its outer diameter close to the inner diameter of the outer tube (1) is inserted into the outer tube (1) and is free to move along in the outer tube (1); the tail of the inner tube (2) is formed a turning ring (21) thicker than that of the inner tube (2) having a plurality ribs (211) to increase friction; a slide trough (21) in proper width is provided from the front edge to the turning ring (21) in the inner tube (21); and an outer flange (23) having its diameter slightly larger than that of the inner tube (2) is provided on the lower end of the inner tube (2).

The slide needle holder (3) related to a cylindrical slide in a diameter slightly smaller than the inner diameter of the outer tube has provided externally a protrusion (31) in proper length and a needle (32) fixed to the center of the slide needle holder (3).

The foil cutter (4) is incorporated to the lower end of and secured to the outer tube (1) by means of an insertion member (41) in a shape matching that of the first flange (13); a stopper (42) is provided in the foil cutter (4) to hold against the opening of a bottle (6); a split, expanding outwardly skirt (43) is provided below the insertion member (41), a round razor (431) is fixed to the inner edge in the skirt (43) and a relative press protrusion (432) is provided on the outer edge of the skirt (43).

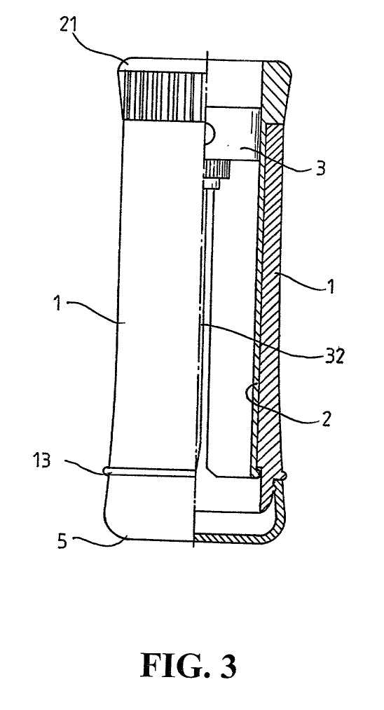

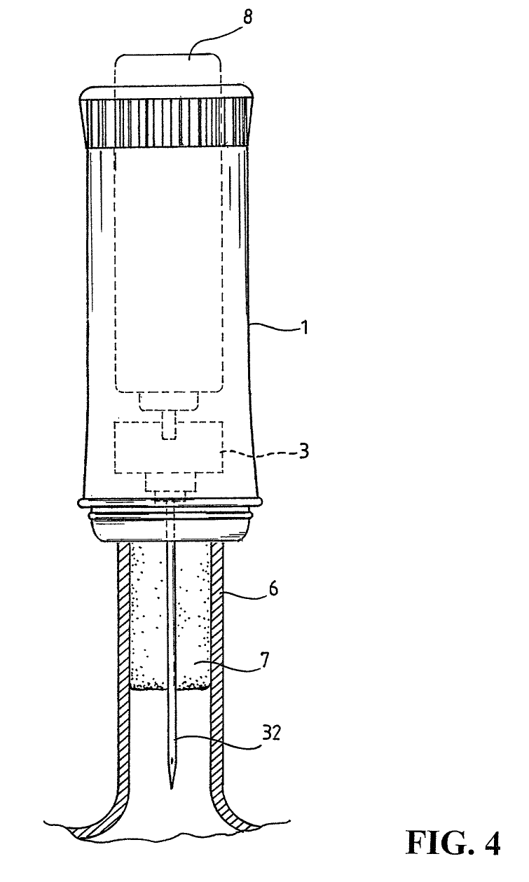

Now also referring to FIG. 3, the slide needle holder (3) is first placed into the inner tube (2) with the protrusion (31) of the slide needle holder (3) resting in the slide trough (22) of the inner tube (2) before both of the slide needle holder (3) and the inner tube (2) are inserted into the outer tube (1). Meanwhile, the protrusion is merely located at the top of the boring lines (12) inside the outer tube (1) and the outer flange (23) of the inner tube (2) merely is merely locked up on to the locking edge (11) to become integrated in one. Upon rotating the inner tube (2) by operating the turning ring (21), the slide needle holder (3) linked to the slide trough (22) slides upward along the boring lines (12) to push out the needle (32) until the protrusion (31) on the slide needle holder (3) reaches the flush trough (121) in the outer tube (1). To remove the cork as illustrated in FIG. 4, the needle (32) is pierced through the cork (7) into the air between the cork (7) and the wine contained in the bottle (6). A coolant canister then is inserted into the inner tube (2) with certain length exposed out of the inner tube (2). The coolant canister (8) is filled with stable, nontoxic, pressurized gas, e.g. coolant or oxygen. By gently pressure the coolant canister (8) to release the pressurized gas in the coolant canister (8) into the bottle (6) where in turn positive pressure is created for easy and fast removal of the cork (7).

To retreat the needle (32), rotate the turning ring (21) in opposite direction. If the corkscrew is not used, a cover (5) is fixed by means of the second flange (14) to cover the lower end of the outer tube (1).

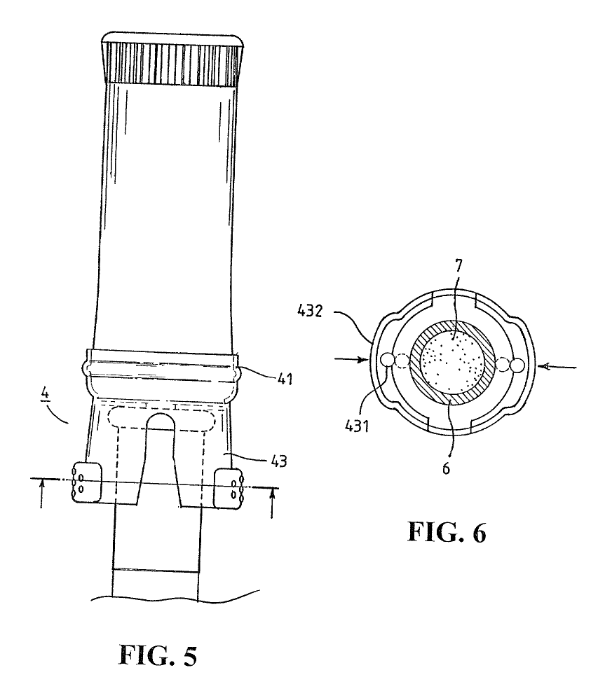

Now referring to FIG. 5, the foil cutter (4) adapted to the present invention is used to cut open the foil covering the opening of the bottle (6) by having covered up the opening of the bottle (6) with the skirt (43) of the foil cutter (4), then the protrusion (432) is pressed and held to rotate the bottle (6) for 360 degrees to allow the round razor (431) provided in the inner edge of the skirt (4) to cut open the foil as illustrated in FIG. 6.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved structure of a corkscrew essentially comprised of an outer tube, an inner tube and a slide needle holder, wherein the outer tube having its lower diameter slightly larger than its upper diameter; a locking edge defined by fall being formed on the lower circumference of the inner diameter; two recessed, boring lines in spiral pattern at a proper angle being formed in the outer tube and terminated to form a flush trough; and a first and a second flanges being formed at the front end of the outer diameter of the outer tube with the first flange in a diameter slightly larger than the outer diameter of the outer tube while the second flange being provided at where appropriately on a tapered bottom of the outer tube; the inner tube with its outer diameter close to the inner diameter of the outer tube being inserted into the outer tube and free to move along in the outer tube; the tail of the inner tube being formed a turning ring, thicker than that of the inner tube; a plurality ribs to increase friction being provided on the turning ring; a slide trough in proper width being provided from the front edge to the turning ring in the inner tube; and an outer flange having its diameter slightly larger than that of the inner tube being provided on the lower end of the inner tube; and the slide needle holder, related to a cylindrical slide in a diameter slightly smaller than the inner diameter of the outer tube having provided externally a protrusion in proper length and a needle being fixed to the center of the slide needle holder; characterized by that the slide needle holder being inserted into the inner tube; with the protrusion of the slide needle holder resting in the slide trough of the inner tube before both of the slide needle holder and the inner tube being inserted into the outer tube; the protrusion being merely located at the top of the boring lines inside the outer tube and the outer flange of the inner tube merely locked up on to the locking edge to become integrated in one; and the slide needle holder being pushed out or retreated by rotating the turning ring.

2. An improved structure of a corkscrew as claimed in claim 1, wherein a foil cutter is adapted to the lower end of the outer tube and secured to the outer tube by means of an insertion member in shape matching that of the first flange of the outer tube.

3. An improved structure of a corkscrew as claimed in claim 2, wherein a stopper is provided inside the foil cutter and a skirt is provided below the insertion member; the skirt at its lower part indicating a split, extending outwardly V shape; a round razor being fixed in the inner edge of the skirt and relatively on the outer edge of the skirt being respectively provided with a pair of press protrusions.
